(19) United States
(12) Patent Application Publication
(10) Pub. No.: US 2023/0145554 A1
(43) Pub. Date: May 11, 2023

(54) SUBSTRATE POROSITY DETERMINATION

(71) Applicant: HEWLETT-PACKARD DEVELOPMENT COMPANY, L.P., Spring, TX (US)

(72) Inventors: Li Qian, Sant Cugat del Valles (ES); Alberto Borrego Lebrato, Sant Cugat del Valles (ES); David Munoz Navarro, Sant Cugat del Valles (ES)

(21) Appl. No.: 17/754,504

(22) PCT Filed: Oct. 21, 2019
(86) PCT No.: PCT/US2019/057266

§ 371 Date: Apr. 4, 2022

(51) Int. Cl. G01N 15/08; G06T 7/00

(52) U.S. Cl. CPC G01N 15/088; G06T 7/001

(57) ABSTRACT

Example implementations relate to substrate porosity determination. Some examples refer to a substrate porosity determination comprising an image capture device a controller to obtain a reference image by the image capture device; obtain a measurement image after a printing operation has been performed on a substrate located over the image capture device; compare the reference image and the measurement image—determine whether the substrate is porous based on the comparison; and determine a print parameter based on the determination of whether the substrate is porous.

### BACKGROUND

A printing device, such as a printer, multifunction printer, or the like, may be used to print content onto a physical medium, such as a substrate. A substrate can be made of a number of different materials. For example, a substrate can be made of a non-porous material such as some self-adhesive vinyls, polyvinyl chloride (“PVC”) banners, papers, polyethylene (“PE”) films, and/or polypropylene (“PP”) films. As another example, a substrate can be made of a porous material, such as some textiles, meshes, and/or other types of woven materials. While in some instances a printing device may be capable of printing on both porous and non-porous materials, these two categories of materials or even particular materials within each category have different physical properties which may result in the use of different printing parameters.

### BRIEF DESCRIPTION OF THE DRAWINGS

The following detailed description references the drawings, wherein:

FIG. 1 is a block diagram of an example printing device consistent with disclosed implementations;

FIG. 2A is an orthogonal view of an example printing device consistent with disclosed implementations;

FIG. 2B is a magnified view of an example print platen of the example printing device shown in FIG. 2A consistent with disclosed implementations;

FIG. 3 is a block diagram of an example printing device consistent with disclosed implementations;

FIG. 4 is a flow chart of an example process for substrate porosity assessment consistent with disclosed implementations;

FIG. 5 is a flow chart of example process for determining porosity of a substrate;

FIG. 6 is a flow chart of an example process for determining an accessory recommendation consistent with disclosed implementations; and

FIG. 7 is a schematic example showing different stages of a porosity determination process according to an example.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

As detailed above, a substrate may be made of a number of different materials that may result in the use of different printing parameters. For example, in some instances, printing on a substrate made of a woven material, such as a textile, a mesh, or the like, does not result in printing fluid, such as ink, passing through the substrate onto the print platen. However, in other instances, printing on a woven material may allow excess printing fluid to pass through the substrate. This pass through of the printing fluid may not only dirty the printer resulting in premature maintenance, but may also cause printer damage due to, for example, printing fluid obstructing printer components, such as the vacuum holes in a print platen. Thus, even if a user of a printer knows the type of substrate material being used, it may be unclear as to whether that material is porous.

A substrate may be considered porous if a printing fluid may pass through the substrate during printing. The present disclosure allows for determining substrate porosity without extensive user involvement, printer downtime, and material waste (e.g., printing fluid and substrate material waste) during testing.

In an example, to help prevent printer damage, a printing device may determine the porosity of a substrate without substantial user involvement and/or advise against printing on a porous substrate without the use of an appropriate accessory.

In particular, the present disclosure refers to a device for substrate porosity determination comprising an image capture device a controller to:
obtain a reference image by the image capture device;
obtain a measurement image after a printing operation has been performed on a substrate located over the image capture device;
compare the reference image and the measurement image
determine whether the substrate is porous based on the comparison; and
determine a print parameter based on the determination of whether the substrate is porous.

The determination of whether a substrate is porous may, e.g., comprise analyzing the measurement image to determine an ink amount on the image capture device. Also, the porosity parameter may be determined based on the ink amount on the image device wherein the ink amount may be calculated, for example, as a difference between the amount of non-void pixels in the reference image and the amount of non-void pixels in the measurement image.

In an example, the determination of non-void pixels may be performed by a controller to:
determine tonal values of the pixels corresponding to the reference image and the measurement image; and
determine that a pixel is non-void if the tonal value exceeds a tonal value threshold

In an example, the substrate is determined to be porous if the ink amount exceeds a predefined threshold value.

In an example, the determination of whether a substrate is porous comprises analyzing the measurement image to determine whether the image includes a repeating pattern.

Furthermore, the reference image may be, e.g., an image of a reference material captured by the image capture device before the printing operation.

As examples of print parameters, the parameters may includes at least one of: issuing a signal corresponding to an accessory recommendation, selecting a drying airflow, selecting an ink density, determining a number of passes, selecting a color profile, selecting a printing mask, or die stitching in case of page-wide array type of printers.

Furthermore, it is disclosed a non-transitory computer-readable storage medium including instructions that, when executed on a controller, cause the controller to:
obtain a reference image;
perform a print operation on a substrate over an image capture device;
obtain a measurement image by the image capture device being the measurement image obtained after the performance of the print operation; and
compare the reference image with the measurement image and, based on the comparison, calculate a porosity of the substrate.
determine a print parameter based on the calculated porosity.

In an example, the reference image is an image obtained by the image capture device before the performance of the print operation.

Moreover, the calculation of the porosity of the substrate may be done, for example, by counting the pixels with tonal values above a predetermined tonal value threshold.

In a further example, the printing parameter includes an accessory recommendation.

Also, the controller may be further to:
determine, whether a repeating pattern is present in the measurement image;
identify a substrate type based on the repeating pattern; and
determine a print parameter based on the substrate type.

In addition, the present disclosure discloses a porosity determination method comprising:
obtain a reference image;
perform a print operation on a substrate over an image capture device;
obtain a measurement image by the image capture device being the measurement image obtained after the performance of the print operation; and
compare the reference image with the measurement image and, based on the comparison, calculate a porosity of the substrate.
determine a print parameter based on the calculated porosity.

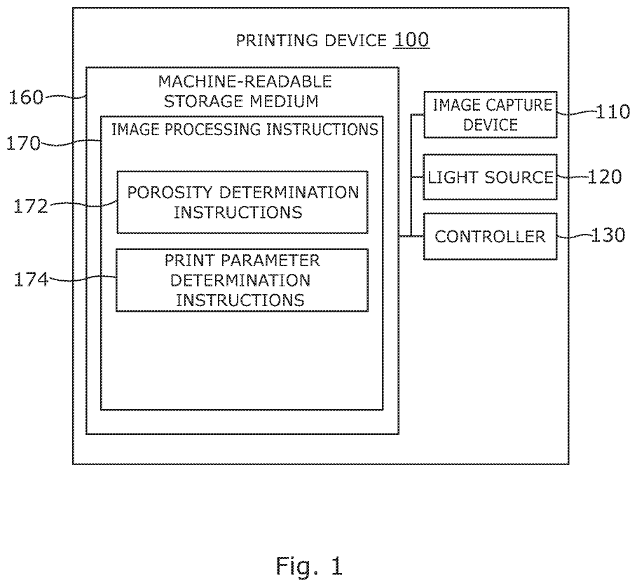

Referring now to the drawings, FIG. 1 is a block diagram of an example printing device 100 consistent with disclosed implementations. Printing device 100 may be implemented in various ways. For example, printing device 100 may be an inkjet printer, a UV printer, a solvent printer, a plotter, and/or any other type of device that can produce content (e.g. images, text, etc.) on a print medium. In the example shown in FIG. 1, printing device 100 may include an image capture device 110, a light source 120, a controller 130, an and a machine-readable storage medium 160.

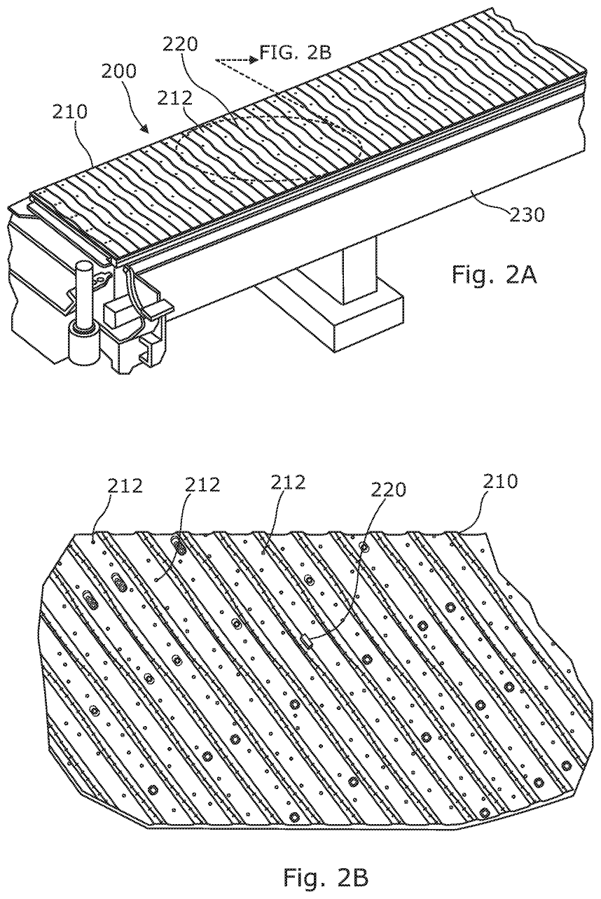

Image capture device 110 may be any device that facilitates the capture of an image. For example, image capture device 110 may be an optical sensor, an image sensor, a digital camera, a video camera, a scanner, and/or any other type of image capture device. In some implementations, image capture device 110 may capture an image of a substrate and provide the captured image and/or data relating to the captured image to a storage device and/or to another component for processing. For example, in some implementations image capture device 110 may capture an image of a substrate under a number of image capture conditions (e.g., using a particular illumination level) and transmit the image and/or data relating to the image to machine-readable storage medium 160 for processing by controller 130. While in the example shown in FIG. 1, image capture device 110 may be integrated with printing device 100 (e.g., located on a print platen, an operating panel, and/or another location of printing device 100), image capture device 110 may be a stand-alone component or collection of components and/or may be integrated with another device. An example of an image capture device integrated with a printing device consistent with disclosed implementations is discussed in more detail below, with respect to, for example, FIGS. 2A and 2B.

Light source 120 may be any light source that illuminates an object, such as a substrate. For example, light source 120 may be a laser, a light emitting diode, an organic light emitting diode, an ultraviolet light, a fluorescent tube, and/or any other type of light source. In some implementations, light source 120 may function to illuminate a substrate so that at least one image of the substrate may be captured by an image capture device, such as image capture device 110. For example, in some implementations, light source 120 may be capable of producing varying light so that image capture device 110 may capture at least one image of the substrate at a particular illumination level and/or at different illumination levels. Light source 120 may be a stand-alone component or collection of components, and/or may be integrated with another device (e.g., integrated with image capture device 110).

Controller 130 may be at least one processing unit (CPU), microcontroller, and/or another hardware device to execute instructions to perform operations. For example, controller 130 may fetch, decode, and execute image processing instructions 170 (e.g., instructions 172, 174) stored in machine-readable storage medium 160 to perform operations related to disclosed examples.

In some implementations, the printing device may also communicate or include a display device that presents information, such as a user interface, to a user operating printing device 100. For example, printing device 100 may present operating screens with menus of different functions, such as menus relating to assessing a substrate that a user desires to load into printing device 100, and/or menus relating to assessing a substrate that is already loaded into printing device 100. In some implementations, a user may select among the functions via an input device of a I/O device. Additionally, in some implementations, the I/O device may display and/or present an alert to a user operating printing device 100. For example, I/O device may present an alert to the user if printing device 100 determines that a substrate is porous.

The machine-readable storage medium 160 may be any electronic, magnetic, optical, or other physical storage device that stores executable instructions. Thus, machine-readable storage medium 160 may be, for example, Random Access Memory (RAM), Electrically-Erasable Programmable Read-Only Memory (EEPROM), a storage drive, an optical disc, and the like. In some implementations, machine-readable storage medium 160 may be a non-transitory computer-readable storage medium, where the term “non-transitory” does not encompass transitory propagating signals. Machine-readable storage medium 160 may be encoded with instructions that, when executed by controller 130, perform operations consistent with disclosed implementations. For example, machine-readable storage medium 160 may include image processing instructions 170 that perform operations that may classify a substrate as porous. In the example shown in FIG. 1, machine-readable storage medium 160 porosity determination instructions 172, accessory recommendation instructions 174 and, in a further example, may include substrate identification instructions.

Porosity determination instructions 172 may function to determine if a substrate is porous. For example, when porosity determination instructions 172 are executed by a controller, such as controller 130 of printing device 100, porosity determination instructions 172 may cause the controller to determine if a substrate is porous based on an image of the substrate. In some examples, porosity determination instructions 172, when executed by controller 130 and/or another controller, may determine whether the substrate is porous by obtaining a measurement image using the image capture device 110 and comparing such measurement image with a reference image. In an example, the reference image may be an image obtained before performing a print operation on a substrate and the measurement image may be obtained after performing a print operation on a substrate located over the image capture device. In particular, during the printing operation of a porous substrate some droplets of printing fluid may pass through the substrate and reach the image capture device 110, therefore, the measurement image, by being taken after the print operation, is indicative of an amount of ink that passes through the substrate and may be used to determine its porosity. In other examples, the reference image may be an image stored in a memory or may be defined as an entirely void image.

In an example, the controller 130 may calculate non-void pixels of the measurement image which, as explained above, are indicative of the porosity of the substrate. These non-void pixels are determined by analyzing the tonal values of each of the pixels and, if a pixel has a tonal value below a determined tonal value threshold, it is considered to be a non-void pixel. The amount of non-void pixels is directly proportional to the porosity of the substrate.

In some examples, porosity determination instructions 172 may also cause controller 130 and/or another controller to store the determination of whether the substrate is porous and/or information related to the determination in machine-readable storage medium 160 and/or in another storage device.

Print parameter determination instructions 174 may function, e.g., to determine whether a printing accessory should be used. For example, when Print parameter determination instructions 174 are executed by a controller, such as controller 130 of printing device 100, such instructions may cause controller 130 and/or another controller to recommend or to not recommend an accessory based on the determination of the identity of the substrate and/or the determination of whether the substrate is porous. For example, if the substrate has a determined porosity, the controller 130 may recommend that a printing accessory be used when printing on the substrate. In some examples, the controller 130 and/or another controller may instruct to prohibit printing on the substrate without a printing accessory. For example, in some implementations printing device 100 may including a printing unit having a combination of hardware and/or programming for applying printing fluid to the substrate, and accessory recommendation instructions 174, when executed by a controller, may function to prevent the printing unit from applying printing fluid to the substrate without the use of the recommended printing accessory. Moreover, in some implementations, accessory recommendation instructions 174, when executed by a controller, may generate an alert that may be displayed on a display device, such as I/O device.

Other examples of print parameter instructions may be determining a drying airflow during a post-print operation of an ink density to be used during a further printing operation.

Substrate identification instructions may function to identify a type substrate, e.g., if a substrate is woven or knitted. For example, when substrate identification instructions are executed by a controller, such as controller 130 of print device 100, substrate identification instructions may cause controller 130 and/or another controller to analyze the measurement image to determine if there is a pattern in the image, such as a repeating pattern representing a weave pattern of a woven substrate (e.g., a repeating pattern representing the frequency and/or periodicity of a weave pattern), In some implementations, substrate identification instructions may also cause a controller to store the image and/or data related to the determination of the substrate type in machine-readable storage medium 160 and/or in another storage device.

Moreover, the arrangement illustrated in FIG. 1 should be interpreted to be an example, and printing device 100 may be implemented in a number of different configurations. For example, while FIG. 1 shows one image capture device 110, light source 120, controller 130, and machine-readable storage medium 160, printing device 100 may include any number of components 110, 120, 130, and 160 as well as other components not depicted in FIG. 1. For example, printing device 100 may omit any of components 110, 120, 130, and 160 and/or combine at least one of components 110, 120, 130, and 160 (e.g., light source 120 may be part of image capture device 110, I/O device 140 may not include an input device, etc.). As another example, while FIG. 1 shows that each of components 110, 120, 130, and 160 are communicatively connected, at least one of components, 110, 120 130, and 160 may not be communicatively connected to other components of printing device 100 or to external components. As yet another example, while FIG. 1 shows that each of components 110, 120, 130, and 160 are internal to printing device 100, at least one of components 110, 120, 130, and 160 may be external to printing device 100. For example, machine-readable storage medium 160 including processing instructions 170 may be located in a computing system external to printing device 100.

FIG. 2A is an orthogonal view of an example printing device 200 consistent with disclosed implementations. In certain aspects, printing device 200 may correspond to printing device 100 of FIG. 1. For example, printing device 200 may perform operations that are the same as or similar to those performed by printing device 100 of FIG. 1. As shown in FIG. 2A, printing device 200 may include a print platen 210, an image capture device 220 located on the print platen (shown in detail in FIG. 2B), and a vacuum beam 230. Print platen 210 may function to hold the substrate during a printing operation. In some implementations, print platen 210 may include a number of holes 212 (shown in detail in FIG. 2B) for pulling the substrate to the surface of the print platen 210 using suction. For example, printing device 200 may include a vacuum pump (not shown) to generate a vacuum in the cavity or cavities enclosed by print platen 210 and/or vacuum beam 230. In some implementations, when air is vacuumed through vacuum beam 230, air may be pulled in through holes 212 in print platen 210, creating suction that may function to hold a substrate to print platen 210.

FIG. 2B is a magnified view of an example print platen 210 of the example printing device 200 shown in FIG. 2A consistent with disclosed implementations. As shown in FIG. 2B, image capture device 220 may be positioned on print platen 210 such that it does not obstruct a vacuum hole 212. In the example shown in FIGS. 2A and 2B, image capture device 220 may be any type of image capture device. For example, in some implementations, image capture device 220 may be an optical sensor including an image sensor, a window, and a fiducial etched into the window (not shown in FIGS. 2A-2B). The fiducial may be a geometric shape (e.g., a circle, a square, etc.) or other visual feature that may be used as a reference point for measurement. In some implementations, when a substrate is placed over image capture device 220, image capture device 220 may capture an image of the substrate, Since, in some implementations, a fiducial may be etched into a window of image capture device 220, an image captured by image capture device 220 may, in some instances, include a representation of the fiducial in the image. In an example, the image capture device may comprise a cap that may be positioned over the window to protect the device, in a further example, the device may take an image with the cap over the window and may use such image as the reference image.

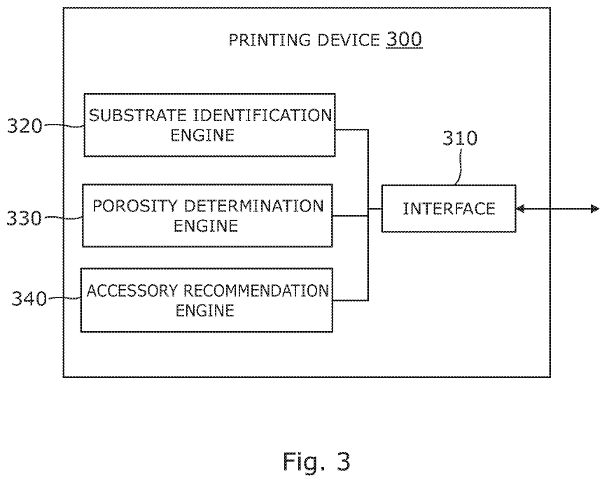

FIG. 3 is a block diagram of an example printing device 300 consistent with disclosed implementations. In certain aspects, printing device 300 may correspond to printing device 100 of FIG. 1 and/or printing device 200 of FIG. 2, Printing device 300 may be implemented in various ways. For example, printing device 300 may be a printer, a special purpose computer, a server, a mainframe computer, a computing device executing instructions that receive and process information and provide responses, and/or any other type of computing system. In the example shown in FIG. 3, printing device 300 may include an interface device 310, a substrate identification engine 320, a porosity determination engine 330, and an accessory recommendation engine 340.

Interface device 310 may be any device that facilitates the transfer of information between printing device 300 and external components. In some examples, interface device 310 may include a network interface device that allows printing device 300 to receive and send data to and from a network. For example, interface device 310 may retrieve and process data related to determining whether a substrate is porous from a printer external to printing device 300.

Engines 320, 330, and 340 may be electronic circuitry for implementing functionality consistent with disclosed examples. For example, engines 320, 330, and 340 may represent combinations of hardware devices and programming to implement functionality consistent with disclosed implementations. In some examples, the functionality of engines 320, 330, and 340 may correspond to operations performed by printing device 100 of FIG. 1 and/or printing device 200 of FIG. 2, such as operations performed when image processing instructions 170 are executed by controller 130. In FIG. 3, substrate identification engine 330 may represent a combination of hardware and programming that performs operations similar to those performed when controller 130 executes substrate identification instructions, e.g., by identifying patterns in the measurement image. Similarly, porosity determination engine 330 may represent a combination of hardware and programming that performs operations similar to those performed when controller 130 executes porosity determination instructions 172, and accessory recommendation engine 340 may represent a combination of hardware and programming that performs operations similar to those performed when controller 130 executes print parameter determination instructions 176.

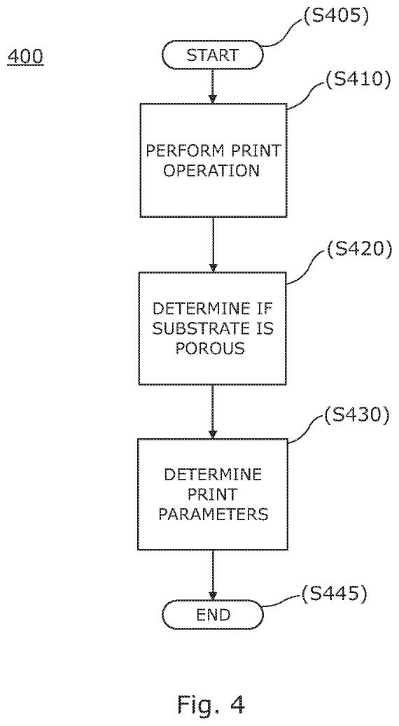

FIG. 4 is a flow chart of an example process 400 for substrate porosity determination in accordance to disclosed implementations, Although execution of process 400 is described below with reference to printing device 100 of FIG. 1 and/or specific components of printing device 100, other suitable systems and devices for execution of at least one block of process 400 may be used. For example, processes described below as being performed by printing device 100 may be performed by printing device 200, printing device 300 and/or any other suitable device. Process 400 may be implemented in the form of executable instructions stored on a storage device, such as a machine-readable storage medium, and/or in the form of electronic circuitry. Process 400 may be performed based on a user input or may be performed automatically (e.g., when a substrate is loaded into a printing device).

Process 400 may start (block S405) when a substrate has been placed in a location that can be accessed by an image capture device. For example, a substrate may be positioned at a location on print device 100 wherein a print operation may be performed by a print engine and wherein the image capture device 120 is located below the substrate opposite to the print engine. In some implementations, the material may automatically be placed in the proper location when the substrate is loaded into a printing device, such as printing device 100. In some implementations, the substrate may be placed in the location by the user. For example, a user may take a small piece of the substrate and position the piece at the appropriate location.

Once the substrate has been placed at the proper location, process 400 may include performing a print operation (block S410) by the print engine. The print engine may eject droplets of printing fluid towards the substrate and, if the substrate has a certain degree of porosity, may travel through the substrate and reach the image capture device, e.g., a windows of the image capture device.

Process 400 includes determining whether the substrate is porous (block S420) based on the measurement image. For example, printing device 100 may analyze the measurement image to determine an amount of ink that has travelled across the substrate and has reached the image capture device, in particular, the substrate may be removed from above the image capture device or a reference substrate may be positioned between the image capture device and the substrate and a measurement image may be taken. In the measurement image, the controller may be to count the pixels which comprise ink, i.e., the non-void pixels.

In an example, a reference image may be taken by the image capture device before the printing operation as to have a calibration value. Such reference image may be taken, e.g., with a reference substrate that may be a blank substrate or a cap of the imaging device. In such a reference image a pixel count may be performed, and such calibration value may be stored in a memory.

Then, a printing operation may be performed on the substrate. Subsequently, the reference substrate may, again, be positioned over the image capture device and the measurement image may be obtained. Then, a pixel count may be performed. The degree of porosity of the substrate may be determined based on the difference between the pixel count of the reference image (i.e., the calibration value) and the pixel count of the measurement image.

In some examples, the reference image may not be used, and the method may assume that the image capture device is clean before the porosity determination, i.e., the calibration value is 0.

In some implementations, printing device 100 may compare a number representing an amount of non-void pixels shown in the image to a threshold value. For example, if the number exceeds the threshold value, then printing device 100 may determine that the substrate is porous. If not, then printing device 100 may determine that the substrate is not porous. Additionally, in some implementations, printing device 100 may determine a degree of porosity of a substrate based on the amount of non-void pixels and, depending on such degree of porosity, different actions may be taken.

Process 400 may also include determining print parameters (block S430). For example, printing device 100 may recommend a printing accessory based on the determination of whether the substrate is porous in block S420 of process 400. In some instances, printing device 100 may recommend a printing fluid collector accessory be used with the printing device if the substrate is porous, and/or may prohibit printing on the substrate without use of the accessory. For example, if the substrate is being assessed while the substrate is loaded in printing device 100, printing device 100 may prevent a printing unit of printing device 100 from applying printing fluid to the substrate until the accessory is attached to or otherwise used by printing device 100. In a further example, the controller may identify a degree of porosity of the substrate and, depending, e.g., on the length of the print job and the degree of porosity determine that the print job may be performed without installing a collector. In other examples, the print parameters that may be set depending on the degree of porosity may be, determining the type of ink collector to use, determining the drying airflow to be used, e.g., in drying/curing operations, determining the ink density to be used during printer, etc.

After the porosity of the substrate is determined (block S420), and/or the print parameters are determined (block S430), process 400 may end (block S445).

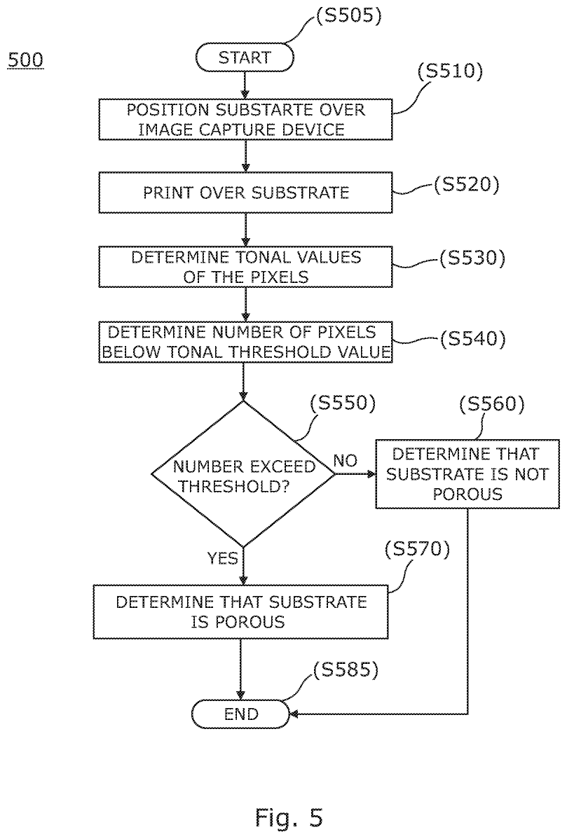

FIG. 5 is a flow chart of example process 500 for determining if a number of voids are present in an image of a substrate according to disclosed implementations. Although execution of process 500 is described below with reference to printing device 100 of FIG. 1 and/or specific components of printing device 100, other suitable systems and devices for execution of at least one block of process 500 may be used. For example, processes described below as being performed by printing device 100 may be performed by printing device 200, and/or any other suitable device. Process 500 may be implemented in the form of executable instructions stored on a storage device, such as a machine-readable storage medium, and/or in the form of electronic circuitry.

Process 500 may start (block S505) may start by positioning the substrate over the image capture device (block S510) and, optionally, capturing a reference image.

Then, a printing operation is performed over the substrate S520. In such a printing operation a pre-defined pattern may be printed on the substrate over the image capture device.

Process 500 may in addition include capturing the measurement image and determining the tonal values of the pixels in the image (block S530). The measurement image may be obtained upon removal of the printed substrate or by positioning a reference substrate between the substrate and the image capture device as to ensure that the measurement image shows the droplets that have passed through the substrate.

A tonal value may represent how light or how dark a pixel is. Generally, a pixel having a larger tonal value (ag a white pixel, with a tonal value of, for example, 256) may be brighter than a pixel having a smaller tonal value (e.g., a black pixel, with a tonal value of, for example, 0). Therefore, in an example, the pixels having a tonal value below a determined threshold are pixels associated to an amount of ink that has passed through the textile and arrived at the image capture device, e.g., at the windows of the image capture device.

Process 500 may include determining the number of pixels below a reference tonal value (block S520). For example, printing device 100 may determine the tonal value for each pixel within the image and sum up the number of pixels in below the threshold tonal value. In some implementations, printing device 100 may determine a percentage of pixels in the image corresponding to the identified set of tonal values. For example, printing device 100 may determine the total number of pixels in the image and divide the total number of pixels in the identified set of tonal values by the total number of pixels in the image.

Process 500 may also include determining whether the number exceeds a threshold tonal value (block S550). For example, printing device 100 and/or another device may set a threshold value that defines an acceptable percentage of pixels in a set of tonal values to determine that the substrate is porous. In some implementations, the threshold value may be based on the illumination level associated with the image. For example, printing device 100 may set a first threshold value based on a first illumination level and a second threshold value based on a second illumination level. In other implementations, the threshold value may be a single value that is set irrespective of the illumination level associated with the image. For example, the first threshold value may be set to be a predetermined number. The percentage of pixels in the set of tonal values, such as the percentage calculated in block 3540, may be compared with the threshold value. In some implementations, if the percentage does not exceed the threshold value (block S550; no), then printing device 100 may determine that the substrate is not porous (block 3560). If the percentage exceeds the threshold value (block S550; yes) then printing device 100 may determine that the substrate is porous (block S570). Printing device 100 may provide data regarding the determination of whether the substrate is porous to a storage device, such as a machine-readable medium, and/or another device for additional processing. Once a determination has been made regarding whether the substrate is porous, process 500 may end (block S585).

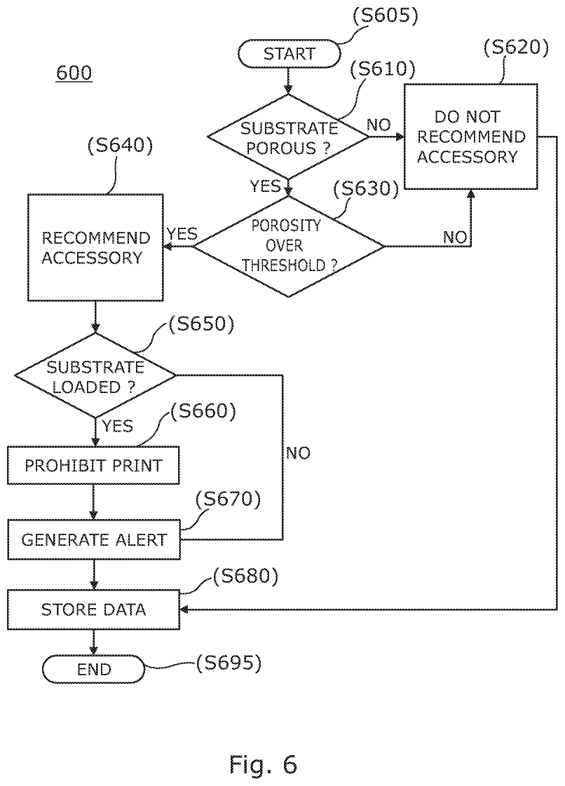

FIG. 6 is a flow chart of an example process 600 for determining an accessory recommendation consistent with disclosed implementations. Although execution of process 600 is described below with reference to printing device 100 of FIG. 1 and/or specific components of printing device 100, other suitable systems and devices for execution of at least one block of process 600 may be used. For example, processes described below as being performed by printing device 100 may be performed by printing device 200, printing device 300 and/or any other suitable device. Process 600 may be implemented in the form of executable instructions stored on a storage device, such as a machine-readable storage medium, and/or in the form of electronic circuitry.

Process 600 may start (block S605) after a determination has been made that the substrate is porous. For example, if printing device 100 has determined that the substrate is not porous (block 3610; no), printing device 100 may not recommend that a printing accessory be used (block 3620). Similarly, if printing device 100 has determined that the substrate is porous but below a determined degree of porosity (i.e., the porosity is within an acceptable degree, e.g.; given that the number of pixels below a value does not exceed a further tonal threshold), printing device 100 may not recommend that a printing accessory be used. Accordingly; in some implementations, if printing device 100 does not recommend the use of an accessory, printing device 100 may print on the substrate without using a printing accessory. Process 1000 may continue by storing data related to the determination that a printing accessory was not needed in a storage device (block S680).

If printing device 100 has determined that is substrate is porous (block S610; yes) and that the porosity of the substrate is has exceed an acceptable degree of porosity (block S630; yes), process 600 may recommend that an accessory be used (block S640). In some implementations, the accessory may be a printing fluid collector accessory, such as an ink collector accessory. Generally, an ink collector accessory may function to collect printing fluid that passes through a substrate. In some implementations, an ink collector accessory may extend under the substrate so that all or most of the printing fluid passing through the substrate is collected. In some examples, depending on the degree of porosity, a specific type of ink collector may be recommended, e.g., of a more absorbent material for higher porosity substrates.

Process 600 may also include determining whether the substrate is loaded in a printing device (block S650). For example, in some implementations, a substrate may be automatically assessed when it is loaded into a printing device consistent with disclosed implementations. Thus, in some implementations, if the substrate is loaded into the printing device (block S650; yes), printing device 100 may prohibit printing on the substrate (block S660). For example, printing device 100 may prohibit a printing unit from applying printing fluid to the substrate.

If printing is prohibited (block 3660; yes), and/or if a substrate is not loaded into a printing device (block S650; no), process 600 may continue by generating an alert indicating that the substrate is porous (block S670). For example, printing device 100 may generate and provide an alert to a display device, such as a display associated with I/O device, and/or any other suitable device. In certain aspects, printing device 100 may generate an alert to include data obtained, for example, from machine-readable medium 160 of printing device 100, another component of printing device 100, and/or another device. In some implementations, printing device 100 may generate the alert such that it includes information about the identity of the substrate (e.g., the degree of porosity of the substrate), whether the substrate is porous, whether an accessory is needed to print on the substrate, and/or the type of accessory to use when printing on the substrate.

Process 600 may also include storing data related to the accessory recommendation (block S680). For example, print device 100 may provide data relating to the accessory recommendation to a storage device, such as a machine-readable medium, and/or another device for additional processing. Examples of data relating to the accessory recommendation may include: the determination of whether the substrate is porous; the determination of the degree of porosity of the substrate; the determination of whether to use a printing accessory; the type of printing accessory recommended; the date of the determination; the time of the determination; the alert; information related to the alert; information related to the user and/or device that initiated the substrate assessment; and/or any other data related to the accessory recommendation. After the determination of whether a printing accessory is needed has been completed, process 600 may end (block S695).

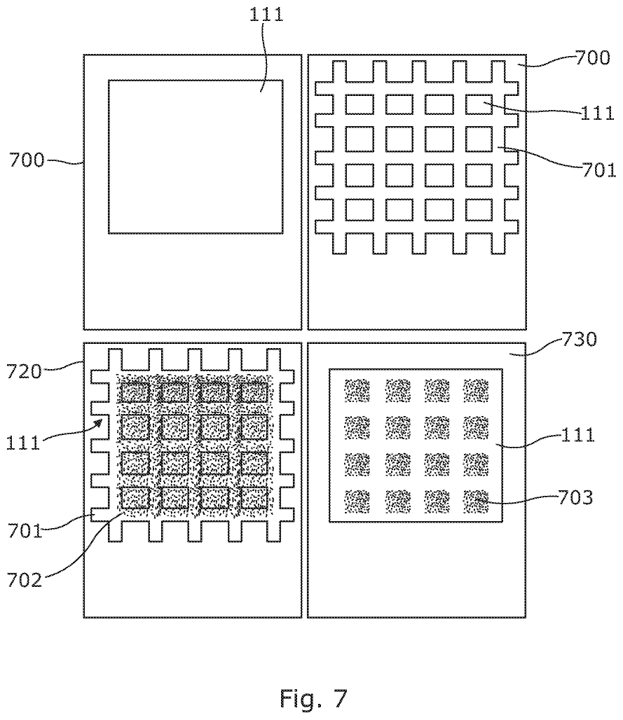

FIG. 7 schematically shows the different scenarios that would occur during a process according to an example.

On a first stage 700 the image capture device may capture a reference image with a reference substrate on top or without any reference. The reference substrate may, in an example, be part of a cap associated to the image capture device. In the example shown in FIG. 7, in a first stage only an image of the window 111 of the image capture device 100 would be captured.

On a further stage 710, a substrate 701 may be positioned over the window 111, in this case, the substrate corresponds to a woven textile.

Then, on stage 720, a printing operation may be performed over the substrate 701 and, in consequence, over the window 111, the printing operation is performed by a print engine and involves ejecting a plurality of printing fluid droplets over the substrate 111. Some of the ink may stay over the substrate and, as can be seen from FIG. 7 some of the droplets may go through the substrate towards the window 111 associated to the image capture device.

On an image acquisition stage 730, for example, after removing the substrate 111 or after positioning a reference substrate between the substrate and the image capture device, the image capture device may obtain a measurement image that shows the residual printing fluid 703 that has gone across the substrate and reached the image capture device window.

The controller may then process the image and determine an indication of the amount of printing fluid that arrived at the image capture device and determine if the substrate is porous and/or the level of porosity of the substrate based on the image and, in particular, based on the amount of pixels that is considered to have printing fluid, e.g., the number of pixels with a tonal value below a threshold tonal value.

The disclosed examples may include systems, devices, computer-readable storage media, and methods for substrate porosity assessment. For purposes of explanation, certain examples are described with reference to the components illustrated in FIGS. 1-3. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by this terms. Instead, these terms are only used to distinguish one element from another.

Further, the sequence of operations described herein are examples and are not intended to be limiting. Additional or fewer operations or combinations of operations may be used or may vary without departing from the scope of the disclosed examples. For example, printing device 100 may receive an image captured by an image capture device external to printing device 100. As another example, the determination of whether a substrate is porous and/or the determination of whether to recommend a printing accessory may be performed. All such modifications and variations are intended to be included within the scope of this disclosure and protected by the following claims.

1. A device for substrate porosity determination comprising an image capture device a controller to:
obtain a reference image by the image capture device;
obtain a measurement image after a printing operation has been performed on a substrate located over the image capture device;
compare the reference image and the measurement image
determine whether the substrate is porous based on the comparison; and
determine a print parameter based on the determination of whether the substrate is porous.

2. The device of claim 1, wherein the determination of whether a substrate is porous comprises analyzing the measurement image to determine an ink amount on the image capture device.

3. The device of claim 2, wherein a porosity parameter is determined based on the ink amount on the image device.

4. The device of claim 3 wherein the ink amount is calculated as a difference between the amount of non-void pixels in the reference image and the amount of non-void pixels in the measurement image.

5. The device of claim 4 wherein determining non-void pixels are identified by using the controller to:
determine tonal values of the pixels corresponding to the reference image and the measurement image; and
determine that a pixel is non-void if the tonal value exceeds a tonal value threshold

6. The device of claim 2, wherein the substrate is determined to be porous if the ink amount exceeds a predefined threshold value.

7. The device of claim 1, wherein the determination of whether a substrate is porous comprises analyzing the measurement image to determine whether the image includes a repeating pattern.

8. The device of claim 1, wherein the reference image is an image of a reference material captured by the image capture device before the printing operation.

9. The device of claim 1, wherein the print parameter includes at least one of: issuing a signal corresponding to an accessory recommendation, selecting a drying airflow, selecting an ink density, number of passes, selecting a color profile, selecting a printing mask, or die stitching.

10. A non-transitory computer-readable storage medium including instructions that, when executed on a controller, cause the controller to:
obtain a reference image;
perform a print operation on a substrate over an image capture device;
obtain a measurement image by the image capture device being the measurement image obtained after the performance of the print operation; and
compare the reference image with the measurement image and, based on the comparison; calculate a porosity of the substrate.
determine a print parameter based on the calculated porosity.

11. The non-transitory computer-readable storage medium of claim 10, wherein the reference image is an image obtained by the image capture device before the performance of the print operation.

12. The non-transitory computer-readable storage medium of claim 10, wherein the calculation of the porosity of the substrate is done by counting the pixels with tonal values above a predetermined tonal value threshold.

13. The non-transitory computer-readable storage medium of claim 10, wherein the printing parameter includes an accessory recommendation.

14. The non-transitory computer-readable storage medium of claim 10, wherein the controller is further to:
determine, whether a repeating pattern is present in the measurement image;
identify a substrate type based on the repeating pattern; and
determine a print parameter based on the substrate type.

15. A porosity determination method comprising:
obtain a reference image;
perform a print operation on a substrate over an image capture device;
obtain a measurement image by the image capture device being the measurement image obtained after the performance of the print operation; and
compare the reference image with the measurement image and, based on the comparison, calculate a porosity of the substrate.
determine a print parameter based on the calculated porosity.
